(19) United States
(12) Patent Application Publication
(10) Pub. No.: US 2024/0086238 A1
(43) Pub. Date: Mar. 14, 2024

(54) GENERAL PURPOSE REAL-TIME SAFETY IMPLEMENTATION ON MPU

(71) Applicant: Baidu USA LLC, Sunnyvale, CA (US)

(72) Inventors: Haofeng KOU, Sunnyvale, CA (US); Davy HUANG, Sunnyvale, CA (US); Manjiang ZHANG, Sunnyvale, CA (US); Helen K. PAN, Sunnyvale, CA (US)

(21) Appl. No.: 17/932,199

(22) Filed: Sep. 14, 2022

(51) Int. Cl. G06F 9/48; G06F 9/455; G06F 9/50; G06F 9/54

(52) U.S. Cl. CPC G06F 9/4893; G06F 9/45558; G06F 9/5033; G06F 9/54; G06F 2009/4557

(57) ABSTRACT

A multiprocessor unit (MPU) in an autonomous driving vehicle (ADV) can provide hard real-time performance. In an embodiment, the MPU can include a hypervisor used to virtualize multiple cores of the MPU, which can further be partitioned into two sets of cores that are isolated from each other. The first set of cores are designated to run real-time related services as trusted applications directly on the hypervisor, and the real-time related services are given higher priority than kernel-level threads on the first set of cores. The second set of cores are designated to run a kernel of an operating system (e.g., Linux). Further, the kernel is patched using a hard real-time open source package to achieve hard real-time performance. An open source package can be used for interprocess communication (IPC) between different electronic control units (ECU) in the ADV.

### TECHNICAL FIELD

Embodiments of the present disclosure relate generally to vehicle operating systems. More particularly, embodiments of the disclosure relate to systems for implementing hard real-time features in a vehicle operation system in an autonomous driving vehicle (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

An ADV includes many hardware and software components that are managed by a vehicle operating system (VOS), which may run on one or multiprocessor units (MPUs) and one or more microcontroller units (MCUs). One popular VOS is Linux due to its friendliness to developers, and easiness for software migration, expansion, revision, and upgrading.

However, Linux does not meet industry standards and certification requirements in terms of real-time and safety, because it is a soft real-time OS on a symmetric multiprocessing (SMP) system without isolation and hard real-time implementation.

For example, for each driving cycle (i.e., frame) of an ADV, more applications may exceed the allowed latency when processing inputs. This latency is particular obvious in the 2D perception module, which may take twice as much time as the allowed latency.

The unsatisfying latency has been a motivation for companies to use different approaches to design specialized scheduling algorithms for autonomous driving vehicles. Some companies use open-source vehicle operations systems, other companies use commercial vehicle operating systems, and yet other companies use non-Linux operating systems. None of the approaches is ideal. The open-source vehicle operating systems may not meet the industry standards and certification requirements, the commercial vehicle operating systems may be too expensive, and the non-Linux vehicle operating systems may have more difficulties and other issues for in-house development.

### BRIEF DESCRIPTION OF THE DRAWINGS

Embodiments of the disclosure are illustrated by way of example and not limitation in the figures of the accompanying drawings in which like references indicate similar elements.

FIG. 1 illustrates a vehicle operation system (VOS) in an autonomous driving vehicle according to an embodiment of the invention.

FIG. 2 illustrates a fastpath package integrated with the VOS in accordance with an embodiment of the invention.

FIG. 3 further illustrates a hypervisor in accordance with an embodiment of the invention.

FIG. 4 further illustrates IPC communication between the MPU and the MCU in accordance with an embodiment of the invention.

FIG. 5 is a block diagram illustrating an autonomous driving vehicle according to one embodiment.

FIG. 6 is a block diagram illustrating an example of an autonomous driving vehicle according to one embodiment.

FIG. 7 is a block diagram illustrating an example of an autonomous driving system used with an autonomous driving vehicle according to one embodiment.

FIGS. 8A and 8B are block diagrams illustrating an example of a sensor unit according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a general-purpose architecture for converting a soft real-time Linux OS on an MPU in an ADV into a hard real-time vehicle OS that can meet industry standards in terms of real-time and safety.

In an embodiment, a multiprocessor unit (MPU) in an autonomous driving vehicle (ADV) can provide hard real-time performance. In an embodiment, the MPU can include a hypervisor used to virtualize multiple cores of the MPU, which can further be partitioned into two sets of cores that are isolated from each other. The first set of cores are designated to run real-time related services as trusted applications directly on the hypervisor, and the real-time related services are given higher priority than kernel-level threads on the first set of cores. The second set of cores are designated to run a kernel of an operating system (e.g., Linux). Further, the kernel is patched using a hard real-time open source package to achieve hard real-time performance. An open source package can be used for interprocess communication (IPC) between different electronic control units (ECU) in the ADV.

In an embodiment, the real-time related services can be affinized to the first set of cores and thus are configured to run only on the first set of cores. A kernel of the VOS (e.g., a Linux kernel) can run on the second set of cores. The hard real-time patch can be a patch to upgrade the existing kernel when the existing kernel has a native configuration. The hard real-time packet can also be a kernel that runs side by side with the existing kernel when the existing kernel is one of the kernels in a dual kernel configuration. In such a case, one of the existing dual kernels can be replaced by the hard real-time kernel.

In an embodiment, the kernel of the VOS can be upgraded to be integrated with an open source fastpath package so that application data can bypass the kernel to increase the throughput of the VOS.

In an embodiment, the MPU can include one or more artificial intelligence (AI) models running on a second set of the plurality of cores of the MPU to manage tasks running on one or more microcontroller units (MCU) of the ADV. The tasks can include a power management task, a temperature management task, and a storage management task. The AI models are trained using data collected from MPUs of a plurality of ADVs.

In an embodiment, the hypervisor is a Type I, microkernel, and G3 hypervisor, and the set of real-time related services include one or more of a networking service, a crypto service, a mission management service, or a communication service.

The various embodiments described can reduce the latency of the VOS, increase its throughput and safety, as well as provide fast data exchange between different ECUs of the VOS.

The other embodiments, functions, and advantages will be apparent from the accompanying drawings and from the detailed description that follows.

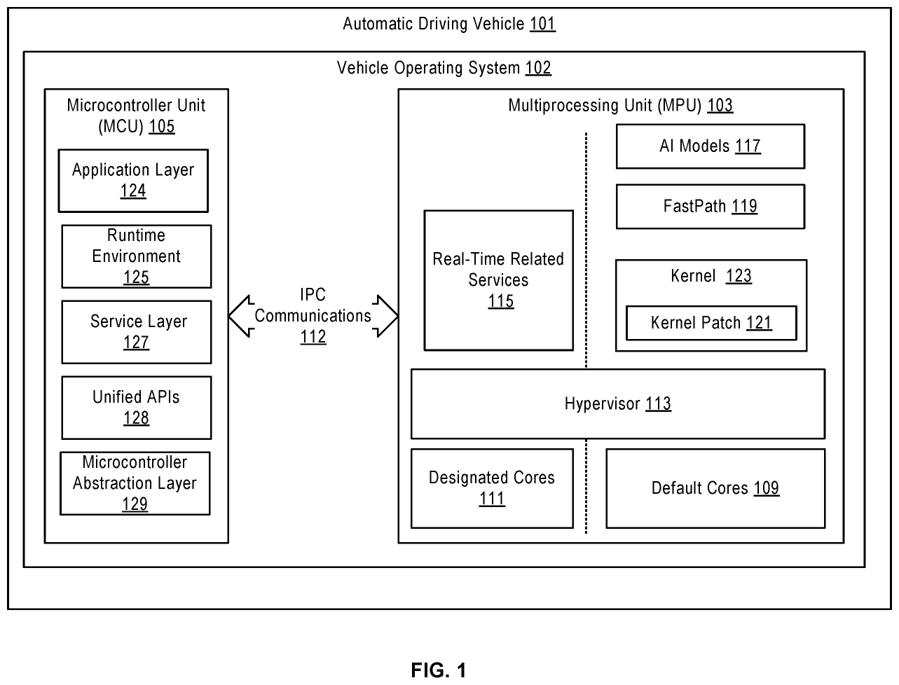

FIG. 1 illustrates a vehicle operation system (VOS) 102 in an autonomous driving vehicle 101 according to an embodiment of the invention.

As used herein and as shown in FIG. 1, the VOS 102 includes hardware and a software stack running on the hardware. The hardware of the VOS 102 includes an MPU 103 and an MCU 105. The software stack of the VOS 102 can be scattered across the MPU 103 and the MCU 105. The MPU 103 can include a kernel 123, a hypervisor 113, one or more real-time related services 115, a kernel patch 121, a fastpath packet 119, and one or more artificial intelligence models 111. The MCU 105 can include a microcontroller abstraction layer (MCAL) 129; a set of unified APIs 128; a service layer 127; a runtime environment 125; and an application layer 124. Both the MCU 105 and the MPU 103 can include multiple cores, each of which can be a central processing unit (CPU), a graphical processing unit (GPU), a digital signal processor (DSP), or another type of processor.

The number of the MPUs, the number of the ECUs, and the number of cores on the MCU 105 and the MPU 103 are all provided for the purpose of illustrating the embodiments of the invention. In actual implementations, these numbers may be different.

The kernel 123 can be responsible for a number of kernel-level tasks, such as scheduling processes, device management, interrupt handling, memory management, and process management. The MPU 103 can communicate with the MCU 105 via interprocess communication (IPC) 111 such that the kernel 123 can schedule processes to run on the cores of the MCU.

As shown in FIG. 1, the multiple cores of the MPU 103 can be partitioned into a first set of cores called designated cores 111 and a second set of cores called default cores 109. The number of cores in each set of cores can be determined users (e.g., vehicle manufacturers) based on their needs and requirements for real-time performance.

As an example, in a 16-core MPU, two cores may be the designated cores 111, and the remaining 14 cores may be default cores 109. The two sets of cores are isolated from each other, with the designated cores 111 supporting the real-time related services 115, and the default cores 109 supporting the AI models 117, the fastpath packet 119, the kernel patch 121, and the kernel 123. The hypervisor 113 can run on any of the designated cores 111 or any of the default cores 109 to virtualize both sets of cores.

In an embodiment, the real-time related services 115 can include a networking service, a communication service, a mission management service, and a crypto service. These services can be affinized to the designated cores 111, and run only on these cores 111.

Further, the real-time related services 115 can be given a priority that is higher than that of kernel-level threads. By default, in a soft real-time system, such as Linux, the kernel-level threads are given the highest priorities because these threads are used by the kernel 123 to provide privileged services to applications, schedule process, and to keep track of what processes are running on the system, how much and which resources are allocated to what process. Thus, execution of the real-time related services 115, in a default Linux system, cannot be guaranteed, and needs to be dependent on the total workload of the system.

Thus, through core partition, services affinization, and kernel thread level downgrading, all the kernel-level threads are either isolated to the default cores 109 or have their priority levels downgraded to levels below that of any of the real-time related services 115, and, thus, the related-time related services 115 can be guaranteed to be executed on the designated cores 111 except when hardware interrupts occur, which effectively converts the VOS 102 into a hard real-time system.

In an embodiment, the kernel patch 121 can be a hard real-time package (e.g., an open source package) or a hard real-time kernel, depending on the configuration of the kernel 123. If the kernel 123 is a native kernel, e.g., MontaVista™, the kernel patch 121 can be modified using the hard real-time package to make the VOS 102 substantially close to hard real-time in terms of performance and/or safety. In an embodiment, the hard real-time package can be one of an open-source package, and can be used to patch of the scheduler of the kernel 123. If the kernel 123 is one of two kernels in a dual kernel configuration, e.g., WindRiver™, the kernel patch 121 can replace one of the two kernels such that the kernel patch 121 can run as a hard real-time kernel in parallel to the kernel that has not been replaced.

For example, the patching kernel (i.e., the kernel patch 121) can run as a hard real-time co-kernel side by side with the other kernel (e.g., a soft real-time kernel) to deal with all time-critical activities, such as handling interrupts, and scheduling real-time threads. The patching kernel can have higher priority over the native kernel activities.

Since the kernel patch 121 is a hard real-time packet, it can convert the VOS 102 to a system with a performance that is substantially close to hard real-time. A hard real-time VOS is a VOS in which a failure to meet even a single deadline may lead to complete or appalling system failure, while a soft real-time VOS is a VOS in which one or more failures to meet the deadline are not considered a complete system failure, but that performance is considered to be degraded.

In an embodiment, the VOS 102 may have a mapping table with entries that map architectures of MPUs (including versions) to modes of configurations (i.e., native kernel or dual kernel). When the VOS 102 needs to be patched to obtain hard real-time performance, the VOS can automatically determine what type of patching package is needed.

In an embodiment, the multiple cores in the MCU 105 can include the same set of services, such as an Ethernet service, a memory service, a diagnostics service, a communication service, or an ECU state management. Each of the services can be customized according to an industry standard, such as the AutoSAR standard. Further, the number of customized services can be adaptively adjusted based on a number of factors, such as the type of industry certification that the VOS needs to pass, and the workload. Each of the cores can also support implementation of custom of functionalities in their respective application layers 113, 127, and 141. Each application can include specific software components and applications that perform specific tasks as per instructions according to an industry standard such as AutoSAR. The number of applications and the type of the applications can also be adaptively adjusted based on the type of industry certification that the VOS needs to pass and customer needs.

The runtime environment on each core can be a middleware layer between the service layer and the application layer, and provides communication services for the application layer. The MCAL on each core implements an interface for the specific microcontroller. Each MCAL has layers of software that are integrated with the MCU 105 through registers, and provides drivers like system drivers, diagnostics drivers, memory drivers, communication drivers (CAN, LIN, Ethernet, etc.), and I/O drivers. The MCU 105 also includes a board support package (BSP) (not shown) with hardware-specific boot firmware and other routines that allow the upper software applications to function in a given hardware environment.

The MCAL 129 as well as the BSP are hardware dependent, which means that they are specific to the MCU 105, which can be one of multiple types. For example, the MCU 105 can be one of a programmable interface controller (PIC) microcontroller, an 8051 microcontroller, an Alf and Vegard's RISC (AVR) microcontroller, an Advanced RISC Machine (ARM) microcontroller, or a Renaissance Semiconductor for Advanced Solutions (Renesas) microcontroller.

In an embodiment, the set of unified APIs 128 can be used to load one or more MCU drivers corresponding to the type of MCU drivers in the MCAL layer for each customized service in the service layer, and to load one or more I/O drivers for I/O devices associated with the MCU 105.

The MCU drivers as discussed above can include system drivers, diagnostics drivers, memory drivers, and communication drivers (CAN, LIN, Ethernet, etc.). These MCU drivers, as well as the I/O drivers, are hardware dependent. Each type of MCU has a specific set of drivers, and each type of I/O device has a specific set of I/O drivers.

In this disclosure, each MCAL can include drivers for multiple types of MCUs, and multiple types of I/O devices. The number of types of MCUs and the types of I/O devices can be adjusted and/or dynamically configured.

In this embodiment, the cores are separated from each other at the level of the hardware and can communicate with each other only at the application level. Thus, the cores, although on the same MCU 105, may have different MCU drivers and different I/O devices due to the architectural differences between each core at the hardware level.

Thus, the unified APIs 128 on each core effectively integrate a device path for each service in the service layer on each core. Each service can have a path on the device (i.e., the core) across the multiple layers of software, including the MCAL and the service layer.

With such vertical integrations by the unified APIs on each core for each service, the set of services and the application tasks can run on any type of MCU and work with any I/O device with proper configurations, despite the hardware dependency of MCU drivers and the I/O drivers. The unified APIs effectively function as a standard wrapper for the low-level details of the hardware on the MCU and the hardware of the cores.

In an embodiment, the unified APIs on each core are identical, the set of services on each core are also identical, and the application tasks on each core can be different. The services and the application tasks on each core can be scheduled by the kernel 123 on the MPU 103, but run asynchronously and independently from each other, such that there is no dependency between services on different cores, and no dependency between application tasks, to ensure hard real-time performance of the VOS 102.

In an embodiment, although the cores are separated at the hardware level, and the services and application tasks on the cores run independently and asynchronously, the cores can communicate with each other using IPC via hardware-protected memories. Each hardware-protected memory can be a region of memory that is protected at the hardware level to prevent access by unauthorized entities, e.g., unauthorized cores.

Each core has a set of hardware-protected memories, including a pair of hardware-protected memories for each other core on the CPU, and the pair of hardware-protected memories is accessible only to the core itself and the other core. The pair of hardware-protected memories includes a write memory and a read memory.

These hardware-protected memories serve as message queues, allowing the cores to communicate with each other via IPC at the application level. However, the services and applications on the cores can run in parallel without interdependency and waiting on each other for hard real-time performance.

In an embodiment, one or more artificial intelligence (AI) models 117 can run on a virtual machine created by a hypervisor 177 on the MPU 103. The AI models 117 can be trained using data collected from MCUs in multiple ADVs and can then be applied to the ADV 101 for inference to maximize the performance of the VOS 102.

In the ADV 101, each MCU includes one or more hardware counters and one or more software counters that can used to collect information from the ADV 101, such as vehicle temperature, power consumption, times of writing to the storage, and application tasks running. A system monitor can receive the collected information from the various counters. Some of the collected information may be manually labeled if necessary. The collected information can then be stored in a cloud for use in training the one or more AI models 117.

In an embodiment, the AI models 117 can be used for prediction and classification. For example, the AI models 117 can predict when the vehicle temperature can reach a peak based on information available, and accordingly schedule tasks to reduce the temperature in advance to prevent the vehicle from running in extremely high temperatures. Similarly, the AI models 117 can schedule application tasks in a manner to avoid excessive writes to the storage, and to avoid unnecessary power consumption to prolong the life of the battery in the ADV 101.

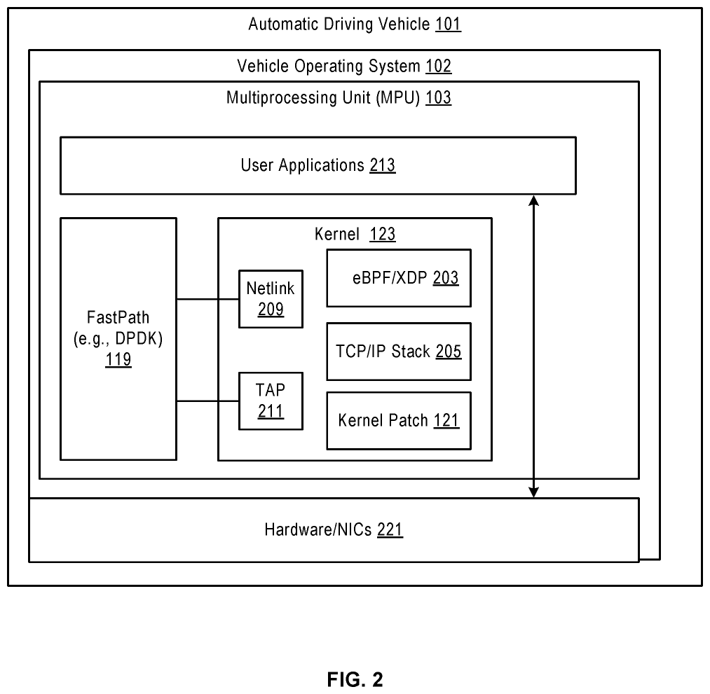

FIG. 2 illustrates a fastpath package 119 integrated with the VOS 102 in accordance with an embodiment of the invention. The fastpath package 119 can increase the throughput of the VOS 102 by allowing data packets to bypass the kernel 123. This feature, coupled with the kernel patch 121 used to reduce the latency of the VOS 102, can further improve the performance of the VOS 102.

As shown in FIG. 2, the fastpath 119 can be an open source package, such as data plane development kit (DPDK). In order to integrate the fastpath 119 and the kernel 123, An extended Berkeley Packet Filter (eBPF) package and an eXpress Data Path (XDP) package 203 can be installed to upgrade the kernel. The eBPF can be used to run sandboxed programs in the kernel 123 without loading kernel modules of the kernel 123 or changing the source code of the kernel, and the XDP is an eBPF-based high-performance data path used to send and receive network packets at high rates by bypassing most layers in a TCP/IP networking stack 205.

Furthermore, a Netlink interface 209 and a tap interface 211 may be installed in the kernel. The Netlink interface 209 can provide an interface used by the applications 213 to communicate with the kernel 123, and the tap interface can inform a Linux bridge to forward Ethernet frames as it is, which means that a virtual machine on the VOS 102 connected to tap interfaces would be able to receive raw Ethernet frames.

With the above patching packages 203 and interfaces 209 and 211 installed in the kernel 123, the kernel 123 would enable data packets to be transmitted directly from the user applications to hardware/network interface cards (NICs) layer 221 without going through the kernel 123, thereby shortening the data path and increasing the throughput of the VOS 102.

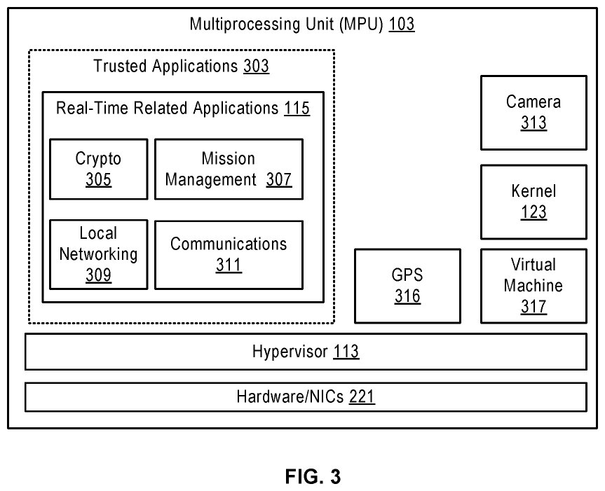

FIG. 3 further illustrates the hypervisor 113 in accordance with an embodiment of the invention. More particularly, FIG. 3 illustrates howe the hypervisor 113 is used to increase the safety and security of the VOS.

The hypervisor 113 can be Type I, microkernel, and G3 hypervisor, which enables one or more services/applications to run directly on the hypervisor 113, rather than on a virtual machine managed by the hypervisor 113.

As shown in FIG. 3, the real-time related applications 115 can directly run on the hypervisor 113 and are designed as trusted applications 303 by the kernel 123. The trusted applications 303 that directly run on the hypervisor 113 are easier to control than those running on a virtual machine, and therefore are safer and more secure. The “trusted application” designation further increases the safety and security of the applications 115.

As further shown, a global positioning system (GPS) 316 is not related to real-time performance and thus is not designed as a trusted application. However, it is still configured to run directly on the hypervisor 113 so that it can be easier to control. In contrast, a camera application 313 and the kernel 123 are configured to run on a virtual machine 317 and thus are not as easy to control or as safe as the real-time related applications 115.

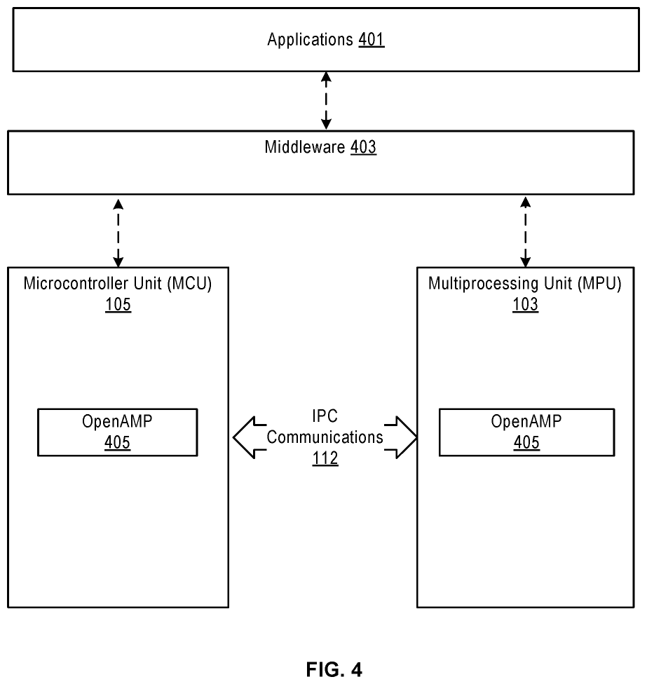

FIG. 4 further illustrates the IPC communication 112 between the MPU 103 and the MCU 105 in accordance with an embodiment of the invention.

The embodiments described in FIGS. 1-3 can improve the latency, the throughput, and the safety and security of the VOS 102. However, the VOS 102 in the ADV 101 is scattered across multiple electronic control units (ECU), with each ECU referring to either an MPU or an MCU. Thus, the communication among the ECUs of the VOS 102 also need to be improved for the VOS 102 to reach a performance level that is close to hard real-time.

As shown in FIG. 3, an open source package (e.g., openAMP package 405) can be used on both the MPU 103 and the MCU 105 so that applications 401 running on the two ECUs can communicate via the IPC 112, rather than through a default client-server model through a middleware 403.

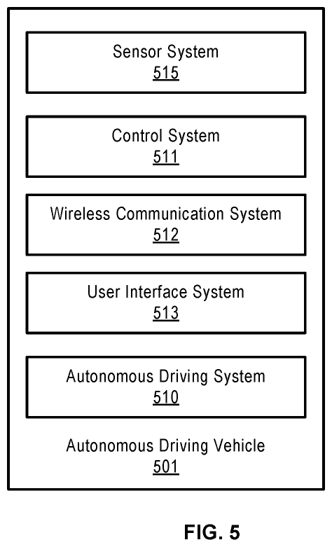

FIG. 5 is a block diagram illustrating an autonomous driving vehicle according to one embodiment of the disclosure. Referring to FIG. 5, autonomous driving vehicle 501 may be the same as ADV 101, and can be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 501 can operate in a manual mode, a full autonomous mode, or a partial autonomous mode.

In one embodiment, autonomous driving vehicle 501 includes, but is not limited to, autonomous driving system (ADS) 510, vehicle control system 511, wireless communication system 512, user interface system 513, and sensor system 515. Autonomous driving vehicle 501 may further include certain common components included in ordinary vehicles, such as, an engine, wheels, steering wheel, transmission, etc., which may be controlled by vehicle control system 511 and/or ADS 510 using a variety of communication signals and/or commands, such as, for example, acceleration signals or commands, deceleration signals or commands, steering signals or commands, braking signals or commands, etc.

Components 510-515 may be communicatively coupled to each other via an interconnect, a bus, a network, or a combination thereof. For example, components 510-515 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

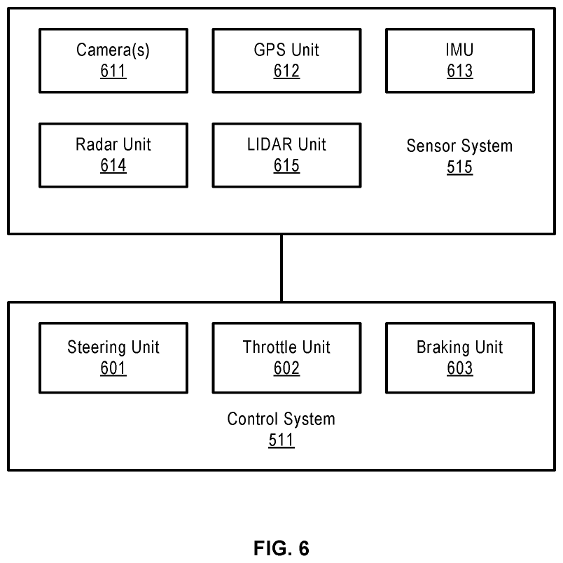

Referring now to FIG. 6, in one embodiment, sensor system 515 includes, but it is not limited to, one or more cameras 611, global positioning system (GPS) unit 612, inertial measurement unit (IMU) 613, radar unit 614, and a light detection and range (LIDAR) unit 615. GPS system 612 may include a transceiver operable to provide information regarding the position of the autonomous driving vehicle. IMU unit 613 may sense position and orientation changes of the autonomous driving vehicle based on inertial acceleration. Radar unit 614 may represent a system that utilizes radio signals to sense objects within the local environment of the autonomous driving vehicle. In some embodiments, in addition to sensing objects, radar unit 614 may additionally sense the speed and/or heading of the objects. LIDAR unit 615 may sense objects in the environment in which the autonomous driving vehicle is located using lasers. LIDAR unit 615 could include one or more laser sources, a laser scanner, and one or more detectors, among other system components. Cameras 611 may include one or more devices to capture images of the environment surrounding the autonomous driving vehicle. Cameras 611 may be still cameras and/or video cameras. A camera may be mechanically movable, for example, by mounting the camera on a rotating and/or tilting a platform.

Sensor system 515 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 511 includes, but is not limited to, steering unit 601, throttle unit 602 (also referred to as an acceleration unit), and braking unit 603. Steering unit 601 is to adjust the direction or heading of the vehicle. Throttle unit 602 is to control the speed of the motor or engine that in turn controls the speed and acceleration of the vehicle. Braking unit 603 is to decelerate the vehicle by providing friction to slow the wheels or tires of the vehicle. Note that the components as shown in FIG. 6 may be implemented in hardware, software, or a combination thereof.

Referring back to FIG. 5, wireless communication system 512 is to allow communication between autonomous driving vehicle 501 and external systems, such as devices, sensors, other vehicles, etc. For example, wireless communication system 512 can wirelessly communicate with one or more devices directly or via a communication network. Wireless communication system 512 can use any cellular communication network or a wireless local area network (WLAN), e.g., using WiFi to communicate with another component or system. Wireless communication system 512 could communicate directly with a device (e.g., a mobile device of a passenger, a display device, a speaker within vehicle 501), for example, using an infrared link, Bluetooth, etc. User interface system 513 may be part of peripheral devices implemented within vehicle 501 including, for example, a keyboard, a touch screen display device, a microphone, and a speaker, etc.

Some or all of the functions of autonomous driving vehicle 501 may be controlled or managed by ADS 510, especially when operating in an autonomous driving mode. ADS 510 includes the necessary hardware (e.g., processor(s), memory, storage) and software (e.g., operating system, planning and routing programs) to receive information from sensor system 515, control system 511, wireless communication system 512, and/or user interface system 513, process the received information, plan a route or path from a starting point to a destination point, and then drive vehicle 501 based on the planning and control information. Alternatively, ADS 510 may be integrated with vehicle control system 511.

For example, a user as a passenger may specify a starting location and a destination of a trip, for example, via a user interface. ADS 510 obtains the trip related data. For example, ADS 510 may obtain location and route data from an MPOI server. The location server provides location services and the MPOI server provides map services and the POIs of certain locations. Alternatively, such location and MPOI information may be cached locally in a persistent storage device of ADS 510.

While autonomous driving vehicle 501 is moving along the route, ADS 510 may also obtain real-time traffic information from a traffic information system or server (TIS). Note that the servers may be operated by a third party entity. Alternatively, the functionalities of the servers may be integrated with ADS 510. Based on the real-time traffic information, MPOI information, and location information, as well as real-time local environment data detected or sensed by sensor system 515 (e.g., obstacles, objects, nearby vehicles), ADS 510 can plan an optimal route and drive vehicle 501, for example, via control system 511, according to the planned route to reach the specified destination safely and efficiently.

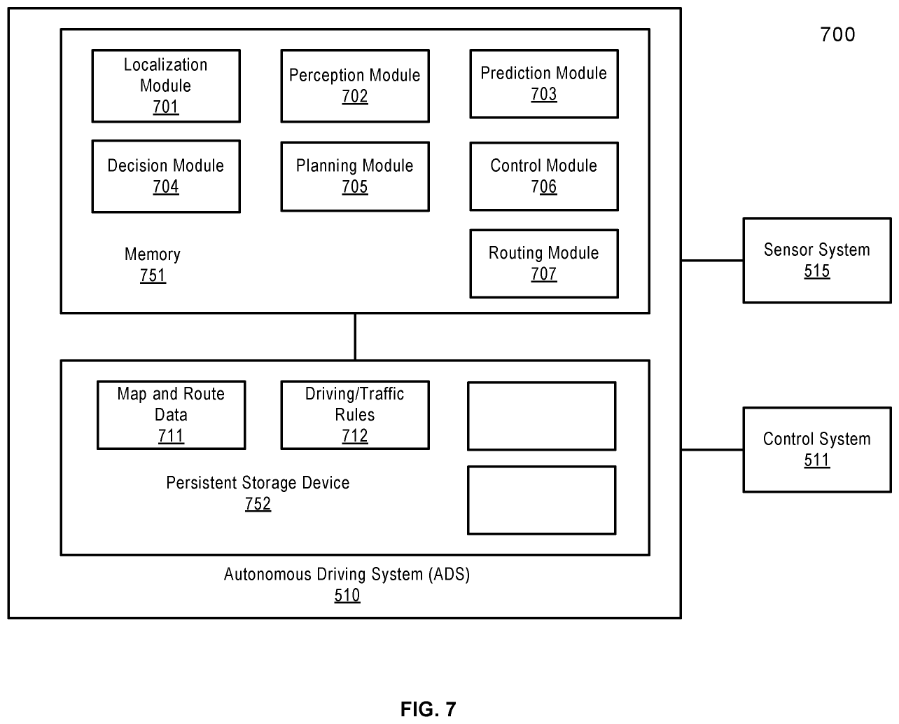

FIG. 7 is a block diagram illustrating an example of an autonomous driving system used with an autonomous driving vehicle according to one embodiment. System 700 may be implemented as a part of autonomous driving vehicle 501 of FIG. 5 including, but is not limited to, ADS 510, control system 511, and sensor system 515. Referring to FIG. 7, ADS 510 includes, but is not limited to, localization module 701, perception module 702, prediction module 703, decision module 704, planning module 705, control module 706, and routing module 707.

Some or all of modules 701-707 may be implemented in software, hardware, or a combination thereof. For example, these modules may be installed in persistent storage device 752, loaded into memory 751, and executed by one or more processors (not shown). Note that some or all of these modules may be communicatively coupled to or integrated with some or all modules of vehicle control system 511 of FIG. 7. Some of modules 701-707 may be integrated together as an integrated module.

Localization module 701 determines a current location of autonomous driving vehicle 501 (e.g., leveraging GPS unit 712) and manages any data related to a trip or route of a user. Localization module 701 (also referred to as a map and route module) manages any data related to a trip or route of a user. A user may log in and specify a starting location and a destination of a trip, for example, via a user interface. Localization module 701 communicates with other components of autonomous driving vehicle 501, such as map and route data 711, to obtain the trip related data. For example, localization module 701 may obtain location and route data from a location server and a map and POI (MPOI) server. A location server provides location services and an MPOI server provides map services and the POIs of certain locations, which may be cached as part of map and route data 711. While autonomous driving vehicle 501 is moving along the route, localization module 701 may also obtain real-time traffic information from a traffic information system or server.

Based on the sensor data provided by sensor system 515 and localization information obtained by localization module 701, a perception of the surrounding environment is determined by perception module 702. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 702 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 702 can also detect objects based on other sensors data provided by other sensors such as a radar and/or LIDAR.

For each of the objects, prediction module 703 predicts what the object will behave under the circumstances. The prediction is performed based on the perception data perceiving the driving environment at the point in time in view of a set of map/rout information 711 and traffic rules 712. For example, if the object is a vehicle at an opposing direction and the current driving environment includes an intersection, prediction module 703 will predict whether the vehicle will likely move straight forward or make a turn. If the perception data indicates that the intersection has no traffic light, prediction module 703 may predict that the vehicle may have to fully stop prior to enter the intersection. If the perception data indicates that the vehicle is currently at a left-turn only lane or a right-turn only lane, prediction module 703 may predict that the vehicle will more likely make a left turn or right turn respectively.

For each of the objects, decision module 704 makes a decision regarding how to handle the object. For example, for a particular object (e.g., another vehicle in a crossing route) as well as its metadata describing the object (e.g., a speed, direction, turning angle), decision module 704 decides how to encounter the object (e.g., overtake, yield, stop, pass). Decision module 704 may make such decisions according to a set of rules such as traffic rules or driving rules 712, which may be stored in persistent storage device 752.

Routing module 707 is configured to provide one or more routes or paths from a starting point to a destination point. For a given trip from a start location to a destination location, for example, received from a user, routing module 707 obtains route and map information 711 and determines all possible routes or paths from the starting location to reach the destination location. Routing module 707 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 704 and/or planning module 705. Decision module 704 and/or planning module 705 examine all of the possible routes to select and modify one of the most optimal routes in view of other data provided by other modules such as traffic conditions from localization module 701, driving environment perceived by perception module 702, and traffic condition predicted by prediction module 703. The actual path or route for controlling the ADV may be close to or different from the reference line provided by routing module 707 dependent upon the specific driving environment at the point in time.

Based on a decision for each of the objects perceived, planning module 705 plans a path or route for the autonomous driving vehicle, as well as driving parameters (e.g., distance, speed, and/or turning angle), using a reference line provided by routing module 707 as a basis. That is, for a given object, decision module 704 decides what to do with the object, while planning module 705 determines how to do it. For example, for a given object, decision module 704 may decide to pass the object, while planning module 705 may determine whether to pass on the left side or right side of the object. Planning and control data is generated by planning module 705 including information describing how vehicle 501 would move in a next moving cycle (e.g., next route/path segment). For example, the planning and control data may instruct vehicle 501 to move 10 meters at a speed of 30 mile per hour (mph), then change to a right lane at the speed of 25 mph.

Based on the planning and control data, control module 706 controls and drives the autonomous driving vehicle, by sending proper commands or signals to vehicle control system 511, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 705 plans a next route segment or path segment, for example, including a target position and the time required for the ADV to reach the target position. Alternatively, planning module 705 may further specify the specific speed, direction, and/or steering angle, etc. In one embodiment, planning module 705 plans a route segment or path segment for the next predetermined period of time such as 5 seconds. For each planning cycle, planning module 705 plans a target position for the current cycle (e.g., next 5 seconds) based on a target position planned in a previous cycle. Control module 706 then generates one or more control commands (e.g., throttle, brake, steering control commands) based on the planning and control data of the current cycle.

Note that decision module 704 and planning module 705 may be integrated as an integrated module. Decision module 704/planning module 705 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 513. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 513. The PNC layer may include functionalities of at least planning module 705 and control module 706. The perception layer may include functionalities of at least perception module 702. In one embodiment, there is an additional layer including the functionalities of prediction module 703 and/or decision module 704. Alternatively, such functionalities may be included in the PNC layer and/or the perception layer. The firmware layer may represent at least the functionality of sensor system 515, which may be implemented in a form of a field programmable gate array (FPGA). The hardware layer may represent the hardware of the autonomous driving vehicle such as control system 511. The application layer, PNC layer, and perception layer can communicate with the firmware layer and hardware layer via the device driver layer.

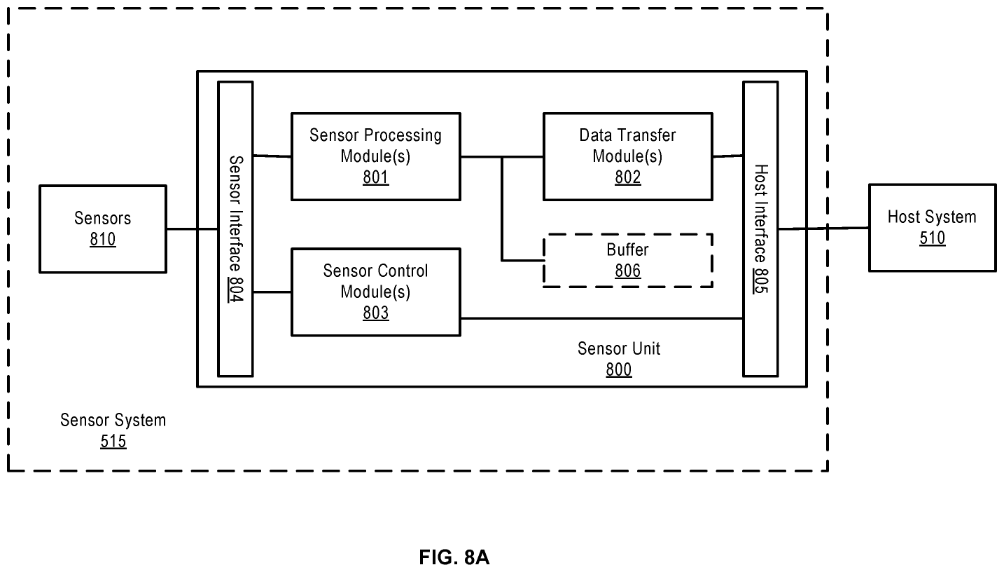

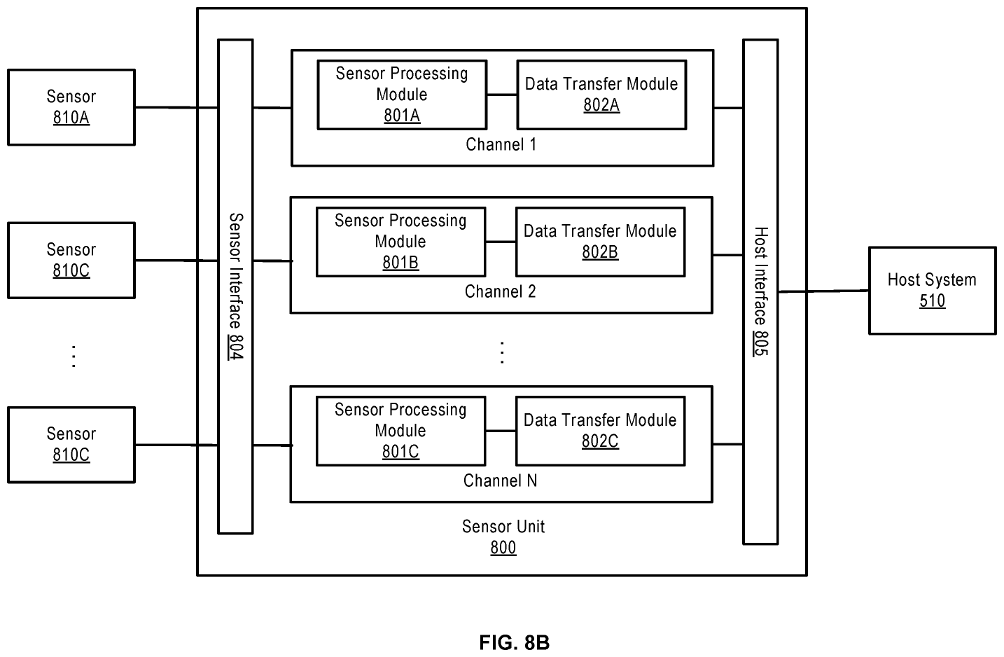

FIG. 8A is a block diagram illustrating an example of a sensor system according to one embodiment of the invention. Referring to FIG. 8A, sensor system 515 includes a number of sensors 810 and a sensor unit 800 coupled to host system 510. Host system 510 represents a planning and control system as described above, which may include at least some of the modules as shown in FIG. 7. Sensor unit 800 may be implemented in a form of an FPGA device or an ASIC (application specific integrated circuit) device. In one embodiment, sensor unit 800 includes, amongst others, one or more sensor data processing modules 801 (also simply referred to as sensor processing modules), data transfer modules 802, and sensor control modules or logic 803. Modules 801-803 can communicate with sensors 810 via a sensor interface 804 and communicate with host system 510 via host interface 805. Optionally, an internal or external buffer 806 may be utilized for buffering the data for processing.

In one embodiment, for the receiving path or upstream direction, sensor processing module 801 is configured to receive sensor data from a sensor via sensor interface 804 and process the sensor data (e.g., format conversion, error checking), which may be temporarily stored in buffer 806. Data transfer module 802 is configured to transfer the processed data to host system 510 using a communication protocol compatible with host interface 805. Similarly, for the transmitting path or downstream direction, data transfer module 802 is configured to receive data or commands from host system 510. The data is then processed by sensor processing module 801 to a format that is compatible with the corresponding sensor. The processed data is then transmitted to the sensor.

In one embodiment, sensor control module or logic 803 is configured to control certain operations of sensors 810, such as, for example, timing of activation of capturing sensor data, in response to commands received from host system (e.g., perception module 702) via host interface 805. Host system 510 can configure sensors 810 to capture sensor data in a collaborative and/or synchronized manner, such that the sensor data can be utilized to perceive a driving environment surrounding the vehicle at any point in time.

Sensor interface 804 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 805 may be any high speed or high bandwidth interface such as PCIe (peripheral component interconnect or PCI express) interface. Sensors 810 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 800. The serial interface such as UART can be coupled with a console system for debug purposes.

Note that sensors 810 can be any kind of sensors and provided by various vendors or suppliers. Sensor processing module 801 is configured to handle different types of sensors and their respective data formats and communication protocols. According to one embodiment, each of sensors 810 is associated with a specific channel for processing sensor data and transferring the processed sensor data between host system 510 and the corresponding sensor. Each channel includes a specific sensor processing module and a specific data transfer module that have been configured or programmed to handle the corresponding sensor data and protocol, as shown in FIG. 8B.

Referring now to FIG. 8B, sensor processing modules 801A-801C are specifically configured to process sensor data obtained from sensors 810A-810C respectively. Note that sensors 810A-810C may the same or different types of sensors. Sensor processing modules 801A-801C can be configured (e.g., software configurable) to handle different sensor processes for different types of sensors. For example, if sensor 810A is a camera, processing module 801A can be figured to handle pixel processing operations on the specific pixel data representing an image captured by camera 810A. Similarly, if sensor 810A is a LIDAR device, processing module 801A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 802A-802C can be configured to operate in different modes, as different kinds of sensor data may be in different size or sensitivities that require different speed or timing requirement. According to one embodiment, each of data transfer modules 802A-802C can be configured to operate in one of a low latency mode, a high bandwidth mode, and a memory mode (also referred to as a fixed memory mode).

When operating in a low latency mode, according to one embodiment, a data transfer module (e.g., data transfer module 802) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 802) is configured to accumulate the sensor data received from a sensor up to a predetermined amount, but is still within the bandwidth the connection between the data transfer module and the host system 510. The accumulated sensor data is then transferred to the host system 510 in a batch that maximum the bandwidth of the connection between the data transfer module and host system 510. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 510, similar to a shared memory page. Examples of the sensor data to be transferred using memory mode include system status data such as temperature, fans speed, etc.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A multiprocessor unit (MPU) in an autonomous driving vehicle (ADV), comprising:
a plurality of cores;
a hypervisor configured to virtualize the plurality of cores; and
a set of real-time related services that are affinized to a first set of cores of the plurality of cores of the MPU, and are configured to run directly on the hypervisor as trusted applications.

2. The MPU of claim 1, further comprising:
one or more artificial intelligence (AI) models running on a second set of cores of the plurality of cores of the MPU to manage a plurality of tasks running on one or more microcontroller units (MCU) of the ADV.

3. The MPU of claim 2, further comprising:
a kernel that runs on the second set of cores; and
a real-time patch that is applied to a scheduler of the kernel to convert the kernel into a hard real-time kernel; or
a real-time kernel that runs in parallel to the kernel.

4. The MPU of claim 3, further comprising:
a fastpath application that applies to the kernel to enable Ethernet data to bypass the kernel.

5. The MPU of claim 2, wherein the plurality of tasks running on the one or more microcontroller units (MCU) of the ADV includes a power management task, a temperature management task, and a storage management task.

6. The MPU of claim 2, wherein the one or more AI models are trained using data collected from MPUs of a plurality of ADVs.

7. The MPU of claim 1, wherein the MPU communicates with each of the one or more MCUs via interprocess communication (IPC).

8. The MPU of claim 1, wherein the hypervisor is a Type I microkernel G3 hypervisor.

9. The MPU of claim 1, wherein the set of real-time related services includes one or more of a networking service, a crypto service, a mission management service, or a communication service.

10. The MPU of claim 1, wherein the MPU includes one or more kernel-level threads and one or more service-level threads on the first set of cores, wherein the each of the one or more service-level threads has a higher priority than each of the one or more kernel-level threads.

11. An autonomous driving vehicle (ADV), comprising:
a multiprocessor unit (MPU), wherein the MPU comprises:
a plurality of cores;
a hypervisor configured to virtualize the plurality of cores; and
a set of real-time related services that are affinized to a first set of the plurality of cores of the MPU, and are configured to run directly on the hypervisor as trusted applications.

12. The ADV of claim 11, wherein the MPU further comprises:
one or more artificial intelligence (AI) models running on a second set of cores of the plurality of cores of the MPU to manage a plurality of tasks running on one or more microcontroller units (MCU) of the ADV.

13. The ADV of claim 12, wherein the MPU further comprises:
a kernel that runs on the second set of cores; and
a real-time patch that is applied to a scheduler of the kernel to convert the kernel into a hard real-time kernel; or
a real-time kernel that runs in parallel to the kernel.

14. The ADV of claim 13, wherein the MPU further comprises:
a fastpath application that applies to the kernel to enable Ethernet data to bypass the kernel.

15. The ADV of claim 12, wherein the plurality of tasks running on the one or more microcontroller units (MCU) of the ADV includes a power management task, a temperature management task, and a storage management task.

16. The ADV of claim 12, wherein the one or more AI models are trained using data collected from MPUs of a plurality of ADVs.

17. The ADV of claim 11, wherein the MPU communicates with each of the one or more MCUs via interprocess communication (IPC).

18. The ADV of claim 11, wherein the hypervisor is a Type I, microkernel, and G3 hypervisor.

19. The ADV of claim 11, wherein the set of real-time related services includes one or more of a networking service, a crypto service, a mission management service, or a communication service.

20. The ADV of claim 11, wherein the MPU includes one or more kernel-level threads and one or more service-level threads on the first set of cores, wherein the each of the one or more service-level threads has a higher priority than each of the one or more kernel-level threads.
